(19) United States
(12) Patent Application Publication
(10) Pub. No.: US 2010/0253809 A1
(43) Pub. Date: Oct. 7, 2010

(54) Round Robin Digital Image Storage Using Parallel Storage Paths in Digital Cameras

(76) Inventor: Gary Horace Jensen, Fruit Heights, UT (US)

Correspondence Address: Gary H. Jensen, 666 South Mountain Road, Fruit Heights, UT, 84037, US

(21) Appl. No.: 12/417,472

(22) Filed: Apr. 2, 2009

(51) Int. Cl. H04N 5/76

(52) U.S. Cl. 348/231.99; 348/E05.025

(57) ABSTRACT

Parallel data paths and round robin image storage will increase data transfer speeds to both IC data storage and wireless storage connections. Data integrity is also helped with images being spread across multiple storage media.

### CROSS-REFERENCE TO RELATED APPLICATIONS Not Applicable.

### FEDERALLY SPONSORED RESEARCH

Not Applicable.

### SEQUENCE LISTING OR PROGRAM

Not Applicable.

### BACKGROUND OF THE INVENTION

1. Field of Invention

This invention relates to storage of image files in digital cameras on removable or external media to be accessed by the user at a later time.

2. Prior Art

### REFERENCES CITED

U.S. Pat. Nos.

| | | |
|---|---|---|
| 5,081,482 | January 1992 | Miki, et al. |
| 5,697,004 | December 1997 | Saegusa, et al. |
| 6,490,419 | December 2002 | Teramoto |

Digital cameras have evolved to the point where multiple manufacturers have implemented the option of using more than one IC card for image storage, two being typical. Some use two of the same type, some use two of different hardware formats. The use of the dual cards has been limited to writing the same image data files to both cards as a backup, or writing the same image in two formats—one format per card.

One of the limiting factors of the IC cards is throughput speed. This becomes more and more an issue with the resolution of cameras increasing, especially with RAW image formats that have larger files. The IC cards are also speeding up, but are still a limitation for speed.

Images are initially stored in an internal buffer. The buffer is then emptied into the IC card(s) or to external storage via wireless connections for later retrieval.

3. Objects and Advantages

By using totally parallel paths to the IC cards or wireless connections on alternating images, image files may be written effectively twice as fast with two IC cards (with the same I/O speed) since one image is being processed on one path while the second image is being processed on the second path. The number of paths is limited by available physical camera space. The processor could output separate images on different paths to keep the IC card(s) and/or wireless connection moving at their maximum rate. Since they are parallel, throughput is increased.

The second advantage of this mechanism is that while it is not totally redundant, if an IC card fails, only alternate images are lost. This is far better than loosing a whole card's images. While the speed is a gain, the alternating images is also a gain in data security.

This is configurable. If only a single card or wireless connection is present, use that path. If two cards are present and equal in size and speed, split the images. If the cards are unequal in size, or a card and a wireless connection is present, then alternate until the smaller device is full, then all images go to the larger device. If the cards and wireless are of different speeds, either alternate or use the next empty path.

This is not limited to only two IC cards or a single card and a wireless connection. Additional cards could be added, physical camera space permitting. It could also include the option of a separate path for wireless connection(s). Each parallel path would improve throughput to memory by allowing the processor to not have to wait for a single path.

### SUMMARY

Parallel hardware paths to multiple storage entities allows multiple images to be stored concurrently, speeding up camera to storage processing and enabling less chance for catastrophic data loss.

### DRAWINGS—FIGURES

FIG. 1—This block diagram shows part of the digital camera functionality. This shows the RAM buffer where incoming images are initially stored until being moved to external (removable) storage. The block diagram shows that the RAM is emptied by moving digital image files to IC or wireless storage. The CPU shown has access to the RAM and hardware independent paths to the external storage devices. This is not an implication of limits on the design. This is a block diagram of a sample configuration. Parallel processors could also be used to move data from the RAM buffer.

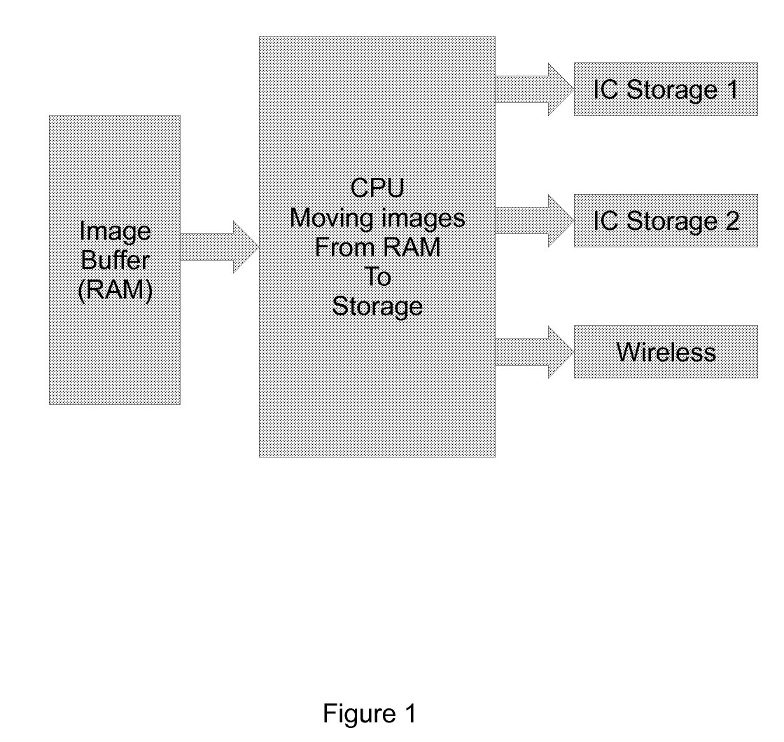

### DETAILED DESCRIPTION

Image capture in digital cameras is very much a three step process. The first is the action of the image sensor capturing the light presented to it. The second is when the capture is then stored as an image in the RAM buffer. The third step is when the image is moved to external/removable storage as an image file (RAW, JPEG, . . . ).

The external storage is either a removable IC chip (Compact Flash or similar) or a wireless connection to an external storage unit. The issue addressed here is the relatively slow speed of the external storage. The sensor and internal RAM are far faster, enabling the camera to capture images faster to RAM than the camera can move the images to external storage. The limitations are hardware/transmission speeds of the external storage.

The CPU can therefore use multiple independent hardware paths to the external storage and rotate image processing as the hardware path becomes available for the next transfer.

The simplest example would be a two IC chip system. The images would be captured to the RAM at high speed. The CPU then would start the transfer of the first image to IC1. IC2 would also be available initially. The CPU then would start the transfer of the second image to IC2. As soon as a new data transfer could occur on IC1, the next part of image one would be transferred. Then as soon as a new data transfer could occur on IC2, the next part of image two would be transferred. Effectively the CPU is simultaneously transferring two images rather than transferring the complete first image to IC1, then the second image to IC1. Note that full image files are not transferred in a single step. Transfers of files are a multiple step process working within the limitation of the hardware interface (bytes, words, buffers . . . ).

The number of parallel transfers would be limited by the number of IC chips physically present and the number of wireless connections present. There are both physical limits and power limits to the number of IC chips and wireless that could be present.

The other limitation is the speed of the CPU. If the CPU cannot transfer images faster than the multiple physical output connections, there is again no speed gain. Multiple processors are an option for moving images to the external storage. Again there are limits for power and processor speed.

As described there are two benefits of this operation. The first is speed of image storage. The second is splitting the storage of images over multiple devices, giving less opportunity for catastrophic data loss with a failure of a single external storage device.

Scheduling Algorithms

Note that the algorithms shown are for illustration and are not the actual code. This shows the process of selecting the next path used to store an image.

The following is a fragment of pseudo-code for the strict round robin scheduling of storage of images.

```
Initially set next output IC1
if image in buffer
    while image in buffer not being stored
        switch ( next output )
            case IC1
                if idle
                    start storage of image
                    next output = IC2
                end if
            case IC2
                if idle
                    start storage of image
                    next output = wireless
                end if
            case wireless
                if idle
                    start storage of image
                    next output = IC1
                end if
        end switch
    end while
end if
```

As this is shown, the images will be stored round robin style in IC1, then IC2, then wireless, then IC1 and so on.

The following is a fragment of pseudo-code for the speed based scheduling of storage of images. It is shown with two IC chips and a wireless. If there are only two IC chips, adjust by removing wireless, etc.

```
Initially set next output IC1
if image in buffer
    while image in buffer not being stored
        switch ( next output )
            case IC1
                if idle
                    start storage of image
                end if
                next output = IC2
            case IC2
                if idle
                    start storage of image
                end if
                next output = wireless
            case wireless
                if idle
                    start storage of image
                end if
                next output = IC1
        end switch
    end while
end if
```

As this is shown, when an image becomes available in the buffer, the first try is to store in the next logical device. If it is not available, then the first idle device encountered in the sequence will get the next image. If three devices as shown were present and had the same storage interface speed, then the images would be output to IC1 then IC2 then wireless, and so on. If speeds differ, then the images would be spread out according to the speed of the devices. If the images coming into the input buffer come in slower than the time to write to the slowest logical device, they will cycle through the sequence.

This allows parallel processing of the images since each path is independent. The path will be busy while outputting the current image to the device on the path. Multiple paths will be utilized as possible.

This does not preclude the use of the parallel paths with different options. The user would still be able to select redundant duplicate storage on two IC chips, or RAW on IC1 and JPEG on IC2, etc. Note that the transfers for redundant storage could be concurrent. Also the RAW/JPEG combination could be concurrent (RAW files are larger, slower).

### OPERATION OF INVENTION

The user first selects the storage media to be used during the photo session. The IC card(s) are inserted into the appropriate slots and wireless (if used) is configured. The user then goes into the camera menu system and selects the data paths to be used from those physically present. The type of image to be stored is selected. Then the storage algorithm is selected: true round robin storage, speed based round robin, or other options as created by the camera manufacturer. Once this is done, the camera software will store incoming images via the selected algorithm to the configured storage paths.

### CONCLUSION, RAMIFICATIONS, AND SCOPE OF INVENTION

This new mechanism for concurrent storage will be a great advantage for the digital camera community. It allows higher rates of image capture which is of great interest to sports and event photographers. It allows spreading images across multiple storage devices to reduce the risk of image loss. It also allows the use of different speed devices without serious limitation to the overall speed of image storage.

Although the description above contains many specificities, these should not be construed as limitations of the scope of invention. This merely provides illustrations of the presently preferred embodiments with todays technology.

1. Alternate images being processed in parallel to separate IC memory cards or wireless connection(s).

2. True round robin storage by cycling through parallel paths.

3. Speed based storage by storing next image via first available storage path.

4. Concurrent image storage of different images on separate media.
